(19) United States
(12) Patent Application Publication
(10) Pub. No.: US 2006/0140623 A1
(43) Pub. Date: Jun. 29, 2006

(54) Aligned lens module for camera

(75) Inventor: Tai-Cherng Yu, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/303,356

(22) Filed: Dec. 16, 2005

(30) Foreign Application Priority Data
Dec. 24, 2004 (CN) 200410091855.6

(51) Int. Cl. G03B 17/00

(52) U.S. Cl. 396/529

(57) ABSTRACT

A lens module (8) includes a housing (10) and a plurality of lenses (21, 22, and 23). The lenses are received in the housing. Each lens has a protrusion (213, 223, and 233) and a hole (214, 224, and 234). The protrusion of a given lens is received in the corresponding hole of an adjacent lens, thereby integrating (i.e., mechanically coupling) the lenses together. Therefore, all the lenses are arranged coaxially.

### BACKGROUND OF THE INVENTION

1. Field of the Invention

The present invention generally relates to lens modules and, more particularly, to a lens module, having aligned lenses therein, for a camera, especially for a camera used in a portable electronic device such as a mobile phone, a PDA (Personal Digital Assistant), and so on.

2. Discussion of the Related Art

With the ongoing development of microcircuitry and multimedia technology, digital cameras are now in widespread use. High-end portable electronic devices, such as mobile phones and PDAs (Personal Digital Assistants), are being developed to be increasingly multi-functional. Many of these portable electronic devices are now equipped with a digital camera. The camera generally includes a lens module and an image sensor module. To enable high quality photos to be taken, the lens module and the image sensor module should, most advantageously, be arranged coaxially with respect to each other.

Referring now to FIG. 4, a conventional lens module (based upon U.S. Pat. No. 4,199,220, dated Apr. 22, 1980, the contents of which are hereby incorporated by reference thereto) for a camera is shown. The lens module includes a housing 60 and four lenses 62. The housing 60 is substantially in the form of a hollow cylinder and has a center cavity 61. The lenses 62 are received in the center cavity 61. However, conventionally, each of the lenses 62 is secured in the housing 60 by glue. As a result, a center axis of a certain lens may be inclined relative to other lenses. The quality of the image captured by these lenses tends to be correspondingly low as a result of such inclination problems.

What is needed, therefore is to provide a lens module, which has a plurality of integrated lenses, co-dependent for the positioning relative to one another.

### SUMMARY OF THE INVENTION

A lens module includes a housing and a plurality of lenses. The lenses are received in the housing. At least a first lens has a protrusion, and at least a second lens has a hole corresponding to the protrusion in the first lens. The protrusion is received in the hole, thereby integrating/coupling the lenses together and aligning such lenses relative to one another.

When the lens module is assembled, the lenses are integrated/aligned by means of the mating of the protrusions and the holes. Therefore, all the lenses are arranged coaxially.

Other advantages and novel features of the preferred embodiment will become more apparent from the following detailed description thereof when taken in conjunction with the accompanying drawings.

### BRIEF DESCRIPTION OF THE DRAWINGS

Many aspects of the present lens module can be better understood with reference to the following drawings. The components in the drawings are not necessarily to scale, the emphasis instead being placed upon clearly illustrating the principles of the present lens module and its potential applications. Moreover, in the drawings, like reference numerals designate corresponding parts throughout the several views.

FIG. 1 is an exploded, cross-sectional view of a camera having the lens module in accordance with a preferred embodiment;

FIG. 2 is an assembled, cross-sectional view of the lens module of FIG. 1;

FIG. 3 is an isometric view of a first lens of the lens module of FIG. 1; and

FIG. 4 is a cross-sectional view of a conventional lens module.

### DETAILED DESCRIPTION OF PREFERRED EMBODIMENTS

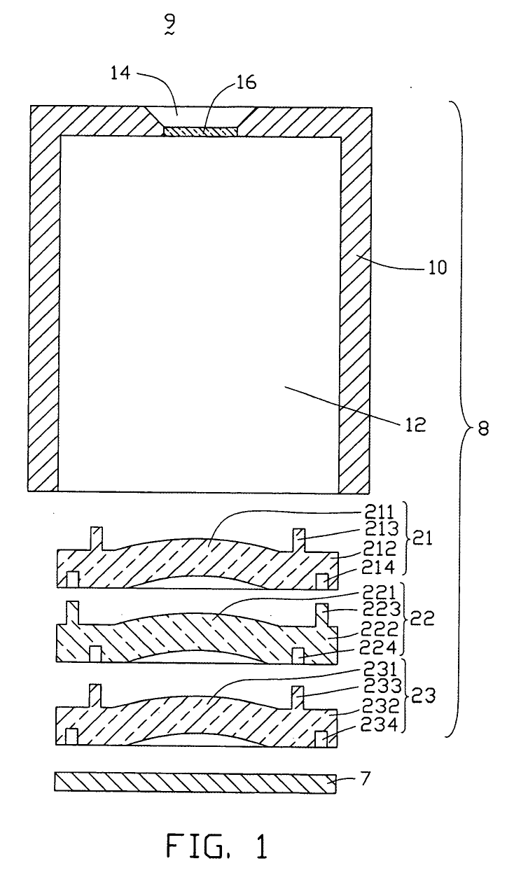

Referring now to the drawings, FIG. 1 shows a lens module 8 for a camera 9 according to a preferred embodiment of the present mechanism. The camera 9 incorporates, for example, an image sensor 7, in addition to the lens module 8. The lens module 8, as illustrated, includes a housing 10, a first lens 21, a second lens 22, and a third lens 23. The three lenses 21, 22, and 23 are received in the housing 10.

The housing 10 is substantially in the form of a hollow cylinder and has a center cavity 12. A first end of the housing 10 is partly closed. An opening 14 is defined in a center portion of the first end. The opening 14 communicates with the center cavity 12 and is, advantageously, covered by a transparent board 16. The transparent board 16 enables light to pass therethrough and protects the lenses 21, 22, and 23 from pollution (i.e., any material which could collect on the lenses and thus degrade the image quality and/or any material which could harm (e.g., etch or scratch) a lens surface) (e.g., dust, other particles, and even environmental gases, especially if used in an industrial situation). An opposite second end of the housing 10 is open, e.g., to accommodate the image sensor 7 and thus allow focusing of an image thereon by the three lenses 21, 22, and 23.

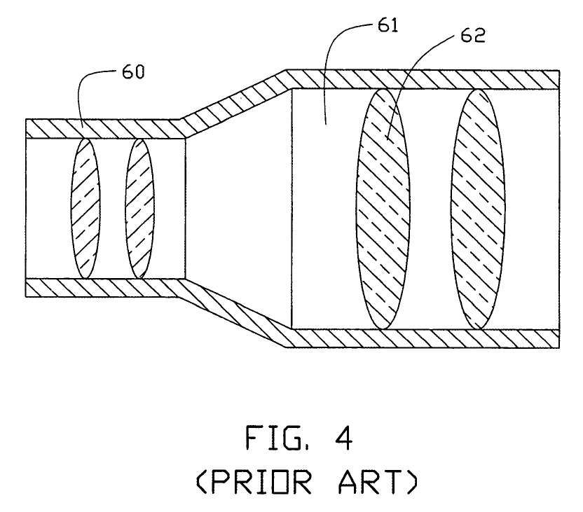

The three lenses 21, 22, and 23 are received in the center cavity 12 of the housing 10. The opening 14 and the three lenses 21, 22, and 23 are coaxially arranged with respect to one another. The first lens 21 includes a lens portion 211, a positioning portion 212, four protrusions 213 (as best seen in FIG. 3), and four holes 214. The lens portion 211 has at least one spherical or aspheric surface and is configured for refracting and/or diffracting light in a manner that helps to facilitate the achievement of the desired focus, using the combination of the three lenses 21, 22, and 23. The positioning portion 212 is substantially an annular board/panel and is adapted/structured for securing the lens portion 211 relative to other such lens portions 211/221 and within the housing 10. The outer diameter of the positioning portion 212 advantageously closely matches the inner diameter of the housing 10, thereby promoting a controlled fitting of the positioning portion 212 within the housing 10. The four protrusions 213 are formed at a first surface of the positioning portion 212 adjacent the lens portion 211. The four protrusions 213 are spaced apart circumferentially according to a predetermined angle. The four holes 214 are formed at an opposite second surface of the positioning portion 212 away from the lens portion 211. The four holes 214 are spaced apart circumferentially according to a predetermined angle. The four protrusions 213 and the four holes 214 are beneficially offset with respect to one another, which should promote lateral stability of the three lenses 21, 22, and 23, relative to one another. Such offsetting also keeps the potential stress concentrators, the holes 214 and the protrusions 213, from being so close to each other, helping to minimize the combined effect they could have on the strength/toughness (i.e., fracture resistance) of the lens 21. That protrusions 213 and holes 214 are round tends to minimize the stress concentrating effect of each. These strength/toughness considerations could be particularly important if an optical glass is used for such a lens 21. The benefits for protrusion/hole offset and shape extend to lenses 22, 23, as well.

The second lens 22, in a manner similar to the first lens 21, includes a lens portion 221, a positioning portion 222, four protrusions 223, and four holes 224. The lens portion 221 has at least one spherical or aspheric surface and is configured for controlling (i.e., refracting and/or diffracting) light in a manner that facilitates the desired focus on the image sensor 7. The positioning portion 222 is substantially an annular board and is adapted for securing the lens portion 221 relative to other such lens portions 211/221 and within the housing 10. The outer diameter of the positioning portion 222 advantageously closely matches the inner diameter of the housing 10, thereby promoting a controlled fitting of the positioning portion 222 within the housing 10. The four protrusions 223 are formed at a first surface of the positioning portion 212 away from the lens portion 211. The four protrusions 223 are spaced apart circumferentially according to a predetermined angle. The four holes 224 are formed at an opposite second surface of the positioning portion 222 adjacent the lens portion 221. The four holes 224 are spaced apart circumferentially according to a predetermined angle. The four protrusions 223 and the four holes 224 are offset with respect to one another. Each of the protrusions 223 is aligned and engaged with a corresponding hole 214 of the first lens 21.

The third lens 23 has similar configuration as the first lens 21 and includes a lens portion 231, a positioning portion 232, four protrusions 233, and four holes 234. Each of the protrusions 233 of the third lens 23 is aligned and engaged with a corresponding hole 224 of the second lens 22.

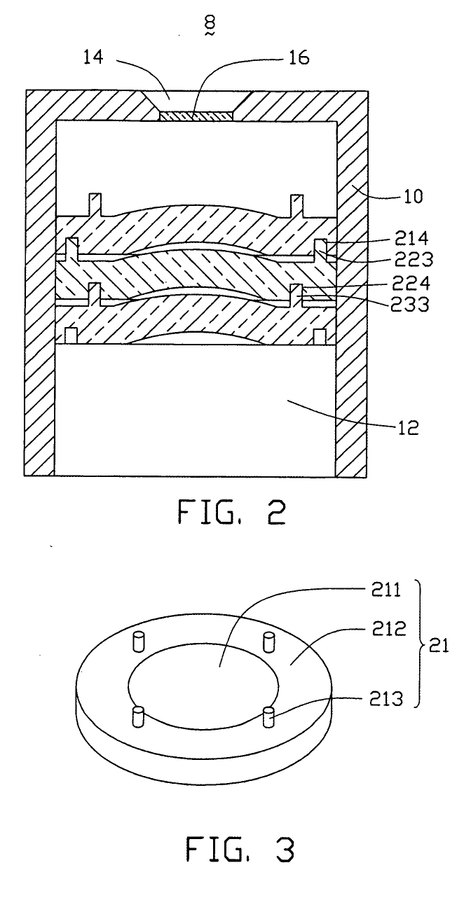

In assembly, the second lens 22 is mounted on a top surface of the third lens 23. The four protrusions 233 of the third lens 23 are respectively received in and thereby mechanically coupled with the four holes 224 of the second lens 22. The first lens 21 is mounted on a top surface of the second lens 22. The four protrusions 223 of the second lens 22 are respectively received in and coupled with the four holes 214 of the first lens 21. The assembled lenses 21, 22, and 23 are inserted into the center cavity 12 of the housing 10 through the open end. An adhesive or glass solder, for example, could be used adjacent housing 10 and/or on at least one positioning portion 212, 222, and/or 232 to permanently attach the three lenses 21, 22, and 23 in the housing 10. Likewise, the respective hole/protrusion combinations could be connected in a similar fashion. Thus, the lens module is assembled completely, as represented in FIG. 2.

It is to be understood that other alternatives could be employed and be within the scope of the present lens module 8. For one, any plurality of lenses can be aligned using the present concept. Also, the number of aligning holes and protrusions may vary, but the number of holes provided on a given lens must be equal to or greater to the number of protrusions present on a mating lens. Further, the holes and protrusions may have other shapes, so long as the shape chosen for a particular protrusion is able to fit within a given hole. It is, however, advantageous, especially if a more fracture-prone material such as optical glass is used for the lenses, that rounded (e.g., cylindrical, ellipsoid) shapes are chosen for the holes/protrusions to avoid stress concentration.

Other yet further alternatives are possible. Ellipsoid shapes would be useful in that fewer hole/protrusion combinations could potentially be used and still gain adequate alignment control, since ellipsoids would not create potential individual pivot points (unlike cylinders). Further, any various known lens materials (e.g., optical glass or plastic) may be used so long as they may be adequately machined and/or molded to provide the desired holes/protrusions. It is further recognized that a lens that will need not mate with the holes of another lens does not have to have protrusions thereon. Conversely, a lens not having to receive protrusions does not require holes therein. It is to be understood that the protrusions and holes could potentially be particularly located to achieve a chosen off-axis alignment (as opposed to axial alignment) and that the present system could broadly used to achieve such goal. The point being is that the present lens alignment system facilitates the fixed lateral alignment of one lens relative to an adjacent lens.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A lens module for a camera, comprising:
a housing, and
at least a first lens and a second lens received in the housing,
wherein at least the first lens has a protrusion, at least the second lens has a hole, and the protrusion of the first lens is received in the hole of the second lens, thereby mechanically coupling the first lens with the second lens.

2. The lens module as claimed in claim 1, wherein the protrusion and the hole are aligned with each other.

3. The lens module as claimed in claim 1, wherein the lens module includes at least one given lens having at least one protrusion and at least one hole associated therewith, the protrusion is formed at one surface of said given lens, and the hole is formed at an opposite surface of said given lens.

4. The lens module as claimed in claim 1, wherein each of the first lens and the second lens includes a lens portion and a positioning portion, and the lens portion thereof is secured to the housing by the positioning portion thereof.

5. The lens module as claimed in claim 4, wherein the protrusion is formed at the positioning portion.

6. The lens module as claimed in claim 4, wherein the hole is formed at the positioning portion.

7. The lens module as claimed in claim 1, wherein at least one surface of each of the first lens and the second lens is spherical or aspheric.

8. The lens module as claimed in claim 1, wherein the housing is substantially in the form of a hollow cylinder.

9. The lens module as claimed in claim 1, wherein one end of the housing is open, and an opposite end of the housing is partly closed, the partly-closed opposite end having an opening therein.

10. The lens module as claimed in claim 9, wherein the opening of the partly-closed opposite end is covered by a transparent board.

11. A digital camera, comprising:
an image sensor configured for receiving an image thereon; and
a lens module mounted adjacent the image sensor, the lens module being configured for focusing an image upon the image sensor, the lens module comprising:
a housing; and
at least a first lens and a second lens received in the housing,
wherein at least the first lens has a protrusion, at least the second lens has a hole, and the protrusion of the first lens is received in the hole of the second lens, thereby mechanically coupling the first lens with the second lens.
